(19) United States
(12) Patent Application Publication
(10) Pub. No.: US 2012/0252432 A1
(43) Pub. Date: Oct. 4, 2012

(54) METHOD, APPARATUS AND COMPUTER PROGRAM PRODUCT FOR OBTAINING DEACTIVATED SECONDARY CELL MEASUREMENTS WHILE A MOBILE TERMINAL IS IN MOTION

(75) Inventor: Tero Henttonen, Espoo (FI)

(73) Assignee: Renesas Mobile Corporation

(21) Appl. No.: 13/078,054

(22) Filed: Apr. 1, 2011

(51) Int. Cl. H04W 24/00

(52) U.S. Cl. 455/422.1

(57) ABSTRACT

A method, apparatus and computer program product are provided that take into account the speed with which a mobile terminal is moving in determining the measurement cycle for one or more deactivated secondary cells. The method, apparatus and computer program product determine a speed with which a mobile terminal is moving and also determine a measurement cycle based upon the speed of the mobile terminal. The method, apparatus and computer program product further cause signals from at least one deactivated secondary cell to be measured in accordance with the measurement cycle.

### TECHNOLOGICAL FIELD

Embodiments of the present invention relate generally to methods and apparatus for obtaining measurements of signals received from one or more deactivated secondary cells and, more particularly, to methods and apparatus for obtaining deactivated secondary cell measurements while a mobile terminal is in motion.

### BACKGROUND

Carrier aggregation is the combination of two or more component carriers (CCs) or cells operating at different frequencies in order to provide a broader transmission bandwidth for a mobile terminal. Depending upon its capabilities, a mobile terminal may simultaneously receive or transmit on one or more of the component carriers. Carrier aggregation may aggregate either contiguous carriers or non-contiguous carriers. In addition, carrier aggregation may operate either intra-band or inter-band. Further, carrier aggregation may support different numbers of downlink component carriers than uplink component carriers. For example, more downlink component carriers may be configured than uplink component carriers.

The component carriers aggregated in accordance with carrier aggregation include a primary cell and one or more secondary cells. The primary cell is the cell that: (i) operates on the primary carrier in which the mobile terminal either performs the initial connection establishment procedure or initiates the connection re-establishment procedure, (ii) was indicated as the primary cell in the handover procedure. Conversely, a secondary cell is a cell, operating on a secondary carrier, which may be configured once radio resource control (RRC) is established and which may be used to provide additional radio resources.

In order to conserve power in an instance in which a mobile terminal is configured for carrier aggregation, a mobile terminal may be commanded to alternately activate and deactivate one or more secondary cells. Notably, the mobile terminal cannot be instructed to deactivate the primary cell, but only one or more of the secondary cells. Once a secondary cell is deactivated, a mobile terminal no longer receives control signals via the packet data control channel (PDCCH) or data via the physical downlink shared channel (PDSCH) for the secondary cell, does not report the channel quality indicator (CQI), the precoding matrix information (PMI) or the rank indication (RI) for the secondary cell, does not transmit on the uplink shared channel (UL/SCH) for the secondary cell and does not transmit the sounding reference signal (SRS) for the secondary cell, thereby conserving power relative to an active secondary cell.

A mobile terminal may monitor signals received from the primary cell and one or more secondary cells to determine which of the cells provide signals of the highest quality, strength or the like. The mobile terminal may be instructed to send measurement reports of specific changes in the relative or absolute signal strengths of the cells. For example, an event may be configured that, in instances in which the mobile terminal determines that a secondary cell provides signals that are of a higher quality, strength or the like than the primary cell, will cause the mobile terminal to send a measurement report to a base station, such as an evolved Node B (eNB), which may change the primary cell designation such that the cell that was previously a secondary cell, but that had the better signal quality, signal strength and the like becomes the primary cell, while the cell that was previously the primary cell becomes a secondary cell.

In instances in which a secondary cell has been deactivated, however, the mobile terminal generally monitors signals received from the deactivated secondary cell on a less frequent basis than the primary cell so as to conserve power. In one example, the mobile terminal repeatedly measures the signals received from the primary cell in accordance with a measurement cycle of 40 ms, while the measurement cycle for the signals received from the secondary cell is thought to range from 160-1280 ms. As a result of the different measurement cycles employed by the mobile terminal for a deactivated secondary cell and the primary cell, the mobile terminal may send measurement reports of changes in the primary cell designation and/or changes of one base station signal compared to another base station signal and/or an absolute threshold based upon outdated signal measurements for the secondary cell. For example, in an instance in which the signal quality and signal strength of the signals received from both the primary cell and a secondary cell are declining over time, a mobile terminal may detect the reduction in signal quality and signal strength of the signals received from the primary cell as a result of the repeated measurement of the signals received from the primary cell. However, in an instance in which the measurement cycle of the signals received from a deactivated secondary cell is longer than the measurement cycle of the primary cell, the mobile terminal may retain outdated signal strength and signal quality measurement for the deactivated secondary cell which do not reflect the further reduction in the signal quality and signal strength of the current signals provided by the secondary cell. As such, the mobile terminal may send measurement reports that will trigger a change of the primary cell designation based upon the outdated signal quality and signal strength measurements of the cell that was formally the secondary cell relative to the more recent signal quality and signal strength measurements of the cell that was formally the primary cell.

After having changed the primary cell designation, the mobile terminal may make additional measurements and send reports that may, in turn, again change the primary cell designation since the mobile terminal may determine that the signal quality and/or strength of the cell that was originally the secondary cell has also declined and that the cell that was originally the primary cell still remains the better option. While described above in the context of an unnecessary change in the primary cell designation, the differences in the measurement cycles may also similarly lead to an unnecessary handover of the mobile terminal to another base station.

The challenges brought about by the different measurement cycles may be exacerbated in an instance in which the mobile terminal is in motion. Indeed, as the measurement cycle of a deactivated secondary cell may be appreciably larger than the measurement cycle of the primary cell, such as 1280 ms relative to 40 ms and since the mobile terminal generally defines a measurement period to consist of a plurality of measurement cycles, such as 5 measurement cycles, a mobile terminal may move a significant distance within the measurement period over which a mobile terminal monitors the signals received from the primary cell and the one or more deactivated secondary cell to determine if a measurement report should be issued that will trigger the primary cell designation to change and/or the handover of the mobile terminal to another base station. Indeed, Table 1 is provided below to illustrate the distances that a mobile terminal may travel within a single measurement period consisting of 5 measurement cycles with one measurement cycle being 160 ms and the other measurement cycle being 1280 ms.

TABLE 1

| Distance mobile | | | | | | | |
|---|---|---|---|---|---|---|---|
| terminal travels within | | | | | | | |
| one measurement | | Speed [km/h] | | | | | |
| period [m] | | 3 | 30 | 50 | 80 | 100 | 120 |
| Meas. | Meas. | 0.83 | 8.33 | 13.89 | 22.22 | 27.78 | 33.33 |
| Cycle | Period = | | | | | | |
| [ms] | 5 * Meas. | | | | | | |
| | Cycle [ms] | | | | | | |
| 160 | 800 | 0.67 | 6.67 | 11.11 | 17.78 | 22.22 | 26.67 |
| 1280 | 6400 | 5.33 | 53.33 | 88.89 | 142.22 | 177.78 | 213.33 |

As illustrated above in Table 1, a mobile terminal may change its position significantly during a measurement period, thereby potentially significantly changing the pathloss associated with the signals received by the mobile terminal from the primary cell and one or more deactivated secondary cells. In this regard, Table 2 is provided below to illustrate the pathloss change (in one specific embodiment, based on a commonly used theoretical pathloss formula that estimates the pathloss without shadowing in the scenario) based upon the change in distance as a function of the initial distance of the mobile terminal from the base station.

TABLE 2

| | Distance | | | | | | | | |
|---|---|---|---|---|---|---|---|---|---|
| | change | Initial distance from base station [m] | | | | | | | |
| | [m] | 50 | 100 | 200 | 250 | 300 | 400 | 500 | 866 |
| Pathloss change | 10 | 2.98 | 1.56 | 0.80 | 0.64 | 0.54 | 0.40 | 0.32 | 0.19 |
| [dB] | 20 | 5.49 | 2.98 | 1.56 | 1.26 | 1.05 | 0.80 | 0.64 | 0.37 |
| | 40 | 9.60 | 5.49 | 2.98 | 2.42 | 2.04 | 1.56 | 1.26 | 0.74 |
| | 60 | 12.88 | 7.67 | 4.28 | 3.51 | 2.98 | 2.28 | 1.85 | 1.09 |
| | 80 | 15.60 | 9.60 | 5.49 | 4.53 | 3.86 | 2.98 | 2.42 | 1.44 |
| | 100 | 17.94 | 11.32 | 6.62 | 5.49 | 4.70 | 3.64 | 2.98 | 1.78 |
| | 140 | 21.80 | 14.30 | 8.66 | 7.26 | 6.25 | 4.90 | 4.03 | 2.45 |

By way of example, the distance between a pair of base stations may be 500 meters such that the typical handover distance is about 250 meters. For a mobile terminal that is moving at a rate of speed of 50 m/h and having a measurement cycle 1280 ms, the mobile terminal will move about 90 m during a measurement period as shown in Table 1. As a result of the distance change of 90 meters, the pathloss change can be approximated to be between about 4.5 dB and 5 dB as shown in Table 2. This pathloss change may be significant in terms of the determination by the measurement report sent by the mobile terminal leading to a change in the primary cell designation or a handover and, in some instances, may cause a primary cell designation to change or may cause a mobile terminal to be handed over in an instance in which the primary cell designation should not have changed or the mobile terminal should not have been handed over.

### BRIEF SUMMARY

A method, apparatus and computer program product of an example embodiment of the present invention take into account the speed with which a mobile terminal is moving in determining the measurement cycle for one or more deactivated secondary cells. As such, the method, apparatus and computer program product of an example embodiment of the present invention may permit more informed decisions to be made regarding a change in the primary cell designation or a handover of the mobile terminal to another base station based upon deactivated secondary cell measurements that are more accurate and timely and, therefore, more properly comparable to the primary cell measurements. However, the method, apparatus and computer program product of an example embodiment of the present invention may continue to endeavor to conserve power by reducing the number of deactivated secondary cell measurements relative to primary cell measurements in instances in which the reduction in deactivated secondary cell measurements will not impair the determination as to the primary cell designation or to handover the mobile terminal to another base station, such as in instances in which the mobile terminal stationary or is moving at a relatively low rate of speed.

In one embodiment, a method is provided that determines a speed with which a mobile terminal is moving and that further determines, via processing circuitry, a measurement cycle based upon the speed of the mobile terminal. The method of this embodiment also causes signals from at least one deactivated secondary cell to be measured in accordance with the measurement cycle.

The method may receive a predefined measurement cycle. In this embodiment, the method may determine the measurement cycle by modifying the predefined measurement cycle based upon the speed of the mobile terminal. In this regard, the predefined measurement cycle may be a maximum measurement cycle.

The method of one embodiment may determine the measurement cycle by determining the measurement cycle in accordance with an inverse relationship relative to the speed of the mobile terminal. The method of one embodiment may determine the measurement cycle by selecting one of a plurality of predetermined measurement cycle levels based upon the speed of the mobile terminal. The method of one embodiment may determine the measurement cycle by determining the measurement cycle in accordance with a predefined formula that is at least partially dependent upon the speed of the mobile terminal.

In another embodiment, an apparatus is provided that includes a processing circuitry configured at least to determine a speed with which a mobile terminal is moving and to determine a measurement cycle based upon the speed of the mobile terminal. The processing circuitry of this embodiment is also configured to cause signals from at least one deactivated secondary cell to be measured in accordance with the measurement cycle.

The processing circuitry may receive a predefined measurement cycle. In this embodiment, the processing circuitry may determine the measurement cycle by modifying the predefined measurement cycle based upon the speed of the mobile terminal. In this regard, the predefined measurement cycle may be a maximum measurement cycle.

The processing circuitry of one embodiment may determine the measurement cycle by determining the measurement cycle in accordance with an inverse relationship relative to the speed of the mobile terminal. The processing circuitry of one embodiment may determine the measurement cycle by selecting one of a plurality of predetermined measurement cycle levels based upon the speed of the mobile terminal. The processing circuitry of one embodiment may determine the measurement cycle by determining the measurement cycle in accordance with a predefined formula that is at least partially dependent upon the speed of the mobile terminal.

In a further embodiment, a computer program product is provided that includes at least one non-transitory computer-readable storage medium having computer-readable program instructions stored therein with the computer-readable program instructions including program instructions configured to determine a speed with which a mobile terminal is moving and to further determine a measurement cycle based upon the speed of the mobile terminal. The program instructions of this embodiment are also configured to cause signals from at least one deactivated secondary cell to be measured in accordance with the measurement cycle.

The computer-readable program instructions may include program instructions configured to receive a predefined measurement cycle. In this embodiment, the program instructions may be configured to determine the measurement cycle by modifying the predefined measurement cycle based upon the speed of the mobile terminal. In this regard, the predefined measurement cycle may be a maximum measurement cycle.

The computer-readable program instructions of one embodiment may include program instructions configured to determine the measurement cycle by determining the measurement cycle in accordance with an inverse relationship relative to the speed of the mobile terminal. The computer-readable program instructions of one embodiment may include program instructions configured to determine the measurement cycle by selecting one of a plurality of predetermined measurement cycle levels based upon the speed of the mobile terminal. The computer-readable program instructions of one embodiment may include program instructions configured to determine the measurement cycle by determining the measurement cycle in accordance with a predefined formula that is at least partially dependent upon the speed of the mobile terminal.

In yet another embodiment, an apparatus is provided that includes means for determining a speed with which a mobile terminal is moving and means for determining a measurement cycle based upon the speed of the mobile terminal. The apparatus of this embodiment also includes means for causing signals from at least one deactivated secondary cell to be measured in accordance with the measurement cycle.

The apparatus may also include means for receiving a predefined measurement cycle. In this embodiment, the means for determining the measurement cycle may include means for modifying the predefined measurement cycle based upon the speed of the mobile terminal. In this regard, the predefined measurement cycle may be a maximum measurement cycle.

The means for determining the measurement cycle may include means for determining the measurement cycle in accordance with an inverse relationship relative to the speed of the mobile terminal. In one embodiment, the means for determining the measurement cycle may include means for selecting one of a plurality of predetermined measurement cycle levels based upon the speed of the mobile terminal. The means for determining the measurement cycle in accordance with one embodiment may include means for determining the measurement cycle in accordance with a predefined formula that is at least partially dependent upon the speed of the mobile terminal.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 is one example of a communication system according to an embodiment of the present invention;

FIG. 2 is a block diagram of an apparatus in accordance with an example embodiment of the present invention; and

FIG. 3 is a flow chart illustrating operations performed by an apparatus in accordance with an example embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

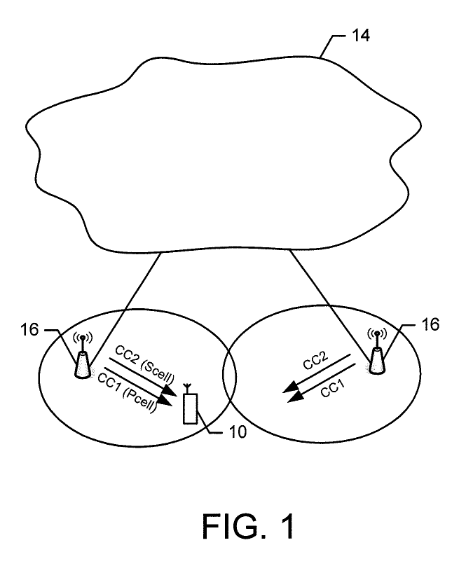

A method, apparatus and computer program product are provided for controlling the rate at which measurements of signals received from one or more deactivated secondary cells are made based upon the speed with which a mobile terminal is moving. Based upon the measurements, the mobile terminal may determine in a more reliable manner whether a measurement report should be sent that may trigger a change in the primary cell designation and/or the handover of the mobile terminal to another base station. In regards to handover, handover is used generally to refer to both handover and cell reselection, including an intra-frequency, inter-frequency or inter-radio access technology (RAT) handover. Although the method, apparatus and computer program product may be implemented in a variety of different systems, one example of such a system is shown in FIG. 1, which includes a first communication device (e.g., mobile terminal 10) that is capable of communication with a network 14 (e.g., a core network). While the network may be configured in accordance with Long Term Evolution (LTE), the network may employ other mobile access mechanisms such as LTE-Advanced (LTE-A), wideband code division multiple access (W-CDMA), CDMA2000, global system for mobile communications (GSM), general packet radio service (GPRS) and/or the like.

The network 14 may include a collection of various different nodes, devices or functions that may be in communication with each other via corresponding wired and/or wireless interfaces. For example, the network may include one or more base stations 16, such as one or more node Bs, evolved node Bs (eNBs), access points or the like, each of which may serve a coverage area divided into one or more cells. The base station or other communication node could be, for example, part of one or more cellular or mobile networks or public land mobile networks (PLMNs). In turn, other devices such as processing devices (e.g., personal computers, server computers or the like) may be coupled to the mobile terminal and/or the second communication device via the network.

A communication device, such as the mobile terminal 10, may be in communication with other communication devices or other devices via the network 14. In some cases, each of the communication devices may include an antenna for transmitting signals to and for receiving signals from a base station 16 via a primary cell (Pcell), such as CC1 in FIG. 1. Although a communication device may be configured to communicate via the primary cell, the communications devices, such as the mobile terminal 10, may also have one or more secondary cells (Scell), such as CC2 in FIG. 1. Some of the secondary cells may be deactivated during various periods of time to conserve power. As described below, signals from the primary cell and the secondary cells, including deactivated secondary cells, may be analyzed by a communication device, such as the mobile terminal, to determine whether a measurement report should be issued that may trigger the primary cell designation to be changed, such as in an instance in which the communication device has a better connection, such as in terms of signal quality, signal strength and/or the like, with a secondary cell, such as a deactivated secondary cell, than with the primary cell or handing over of the communication device to another base station, such as in an instance in which the communication device has a better connection with the other base station.

In some example embodiments, the mobile terminal 10 may be a mobile communication device such as, for example, a mobile telephone, portable digital assistant (PDA), pager, laptop computer, or any of numerous other hand held or portable communication devices, computation devices, content generation devices, content consumption devices, or combinations thereof. As such, the mobile terminal may include one or more processors that may define processing circuitry either alone or in combination with one or more memories. The processing circuitry may utilize instructions stored in the memory to cause the mobile terminal to operate in a particular way or execute specific functionality when the instructions are executed by the one or more processors. The mobile terminal may also include communication circuitry and corresponding hardware/software to enable communication with other devices and/or the network 14.

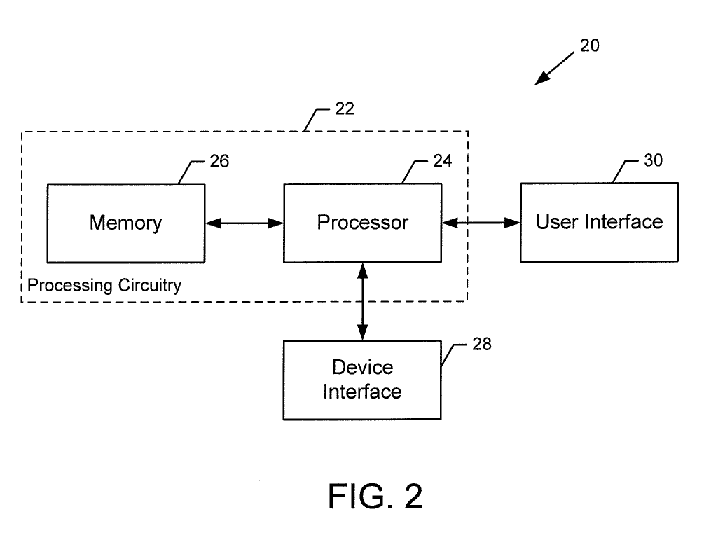

In one embodiment, for example, the mobile terminal 10 may be embodied as or otherwise include an apparatus 20 as generically represented by the block diagram of FIG. 2. In this regard, the apparatus may be configured to evaluate the signals received from the primary cell and from one or more secondary cells and to determine based upon those signals and the speed with which the mobile terminal is moving as to a measurement report should be issued that may trigger a change in the primary cell designation or may trigger service for the mobile terminal being handed over from one base station to another base station. While the apparatus may be employed, for example, by a mobile terminal, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with processing circuitry 22 that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 26 that may be in communication with or otherwise control a device interface 28 and, in some cases, a user interface 30. As such, the processing circuitry may be embodied as a circuit chip (e.g., an integrated circuit chip) configured (e.g., with hardware, software or a combination of hardware and software) to perform operations described herein. However, in some embodiments taken in the context of the mobile terminal 10, the processing circuitry may be embodied as a portion of a mobile computing device or other mobile terminal.

The user interface 30 (if implemented) may be in communication with the processing circuitry 22 to receive an indication of a user input at the user interface and/or to provide an audible, visual, mechanical or other output to the user. As such, the user interface in the context of a mobile terminal 10 may include, for example, a keyboard, a mouse, a joystick, a display, a touch screen, a microphone, a speaker, and/or other input/output mechanisms.

The device interface 28 may include one or more interface mechanisms for enabling communication with other devices and/or networks. In some cases, the device interface may be any means such as a device or circuitry embodied in either hardware, or a combination of hardware and software that is configured to receive and/or transmit data from/to a network 14 and/or any other device or module in communication with the processing circuitry 22. In this regard, the device interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 26 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 26 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

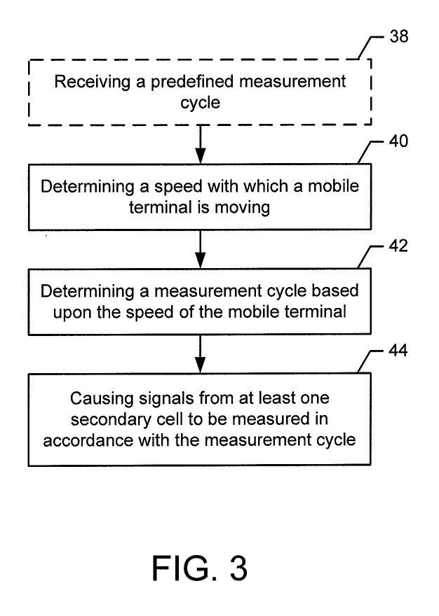

Referring now to FIG. 3, a flowchart illustrating the operations performed by a method, apparatus and computer program product, such as apparatus 20 of FIG. 2, in accordance with one embodiment of the present invention are illustrated. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

As shown in FIG. 1, the mobile terminal 10 may be in communication with the network 14 via a base station 16. In accordance with an example embodiment, the mobile terminal may support carrier aggreagation such that a base station and the mobile terminal are configured to communicate via a plurality of component carriers or cells, each of which operate at a different frequency, thereby providing a greater bandwidth for the mobile terminal. As shown in FIG. 1, one of the carriers, such as CC1, is designated as a primary cell, while the other carriers are designated as secondary cells, such as CC2. In order to conserve power, one or more of the secondary cells may be deactivated. As a first example, when mobile terminal no longer requires a high datarate, the base station may choose to deactivate a secondary cell. As a second example, a base station may notice that the pathloss difference between the primary and secondary cells is large enough to cause problems, and may choose to adapt to this situation by deactivating the secondary cell. As a third example, the base station may have configured a timer based on the activity of the mobile terminal that, on expiry, may cause the secondary cell to be deactivated if there has been no data scheduled for the secondary cell. The mobile terminal may make measurements of one or more parameters associated with the signals received from the primary cell and the signals received from one or more secondary cells, including one or more deactivated secondary cells. Based upon these measurements, the mobile terminal may determine whether it should send a measurement report that may cause the base station to decide that the primary cell designation should be changed, such as from the cell that is currently the primary cell to a cell that is currently a secondary cell. Additionally, the mobile terminal may send a measurement report that causes the base station to determine if the mobile terminal should be handed over or at least if a report should be issued to the network that may commence handover operations.

As described below, the apparatus 20 embodied, for example, by the mobile terminal 10 may take into account the speed with which the mobile terminal is moving and may adjust the measurement cycle at which the mobile terminal monitors the signals from the deactivated secondary cells in response to the speed with which the mobile terminal is moving. In this regard and with reference to block 40 of FIG. 3, the apparatus may include means, such as the processing circuitry 22, the processor 24 or the like, for determining a speed with which the mobile terminal is moving. The speed with which the mobile terminal is moving may be determined in various manners including, for example, by a global positioning system (GPS) or other positioning method, such as those employing accelerometers providing the speed to the processing circuitry or providing data from which the processing circuitry may determine the speed. The processing circuitry may also determine, e.g., estimate, the speed of the mobile terminal according to state information using the number of cell reselections/handovers. In this regard, the processing circuitry may determine the number of reselections/handovers in a predefined period of time. Based upon the number of reselections/handovers, the processing circuitry may determine the mobile terminal to a predefined speed, such as, for example, one of a predefined low speed, intermediate speed or high speed depending upon whether the number of reselections/handovers is less than a minimum threshold, is between the minimum threshold and a maximum threshold or is greater than the maximum threshold, respectively. Alternatively, the processing circuitry may be configured to determine the speed of the mobile terminal in an implicit manner such as based upon the triggering of measurement reports based upon various filtered measurements. For example, the processing circuitry of this embodiment may be configured to determine that the mobile terminal is moving at a predetermined fast speed if short filtered reports are triggered or at a predetermined slow speed if long filtered reports are triggered. While example embodiments are described above in regards to the determination of the speed of the mobile terminal, the mobile terminal, such as the processing circuitry, may determine the speed in a variety of other manners if so desired.

The apparatus 20 may also include means, such as the processing circuitry 22, the processor 24 or the like, for determining a measurement cycle based upon the speed of the mobile terminal 10, as shown in block 42 of FIG. 3. The apparatus, such as the processing circuitry, may determine the measurement cycle in various manners. In one embodiment, however, the processing circuitry is configured to determine the measurement cycle in accordance with an inverse relationship relative to the speed of the mobile terminal. In this regard, as the speed of the mobile terminal increases, the apparatus, such as the processing circuitry, may reduce the measurement cycle such that the apparatus, such as the processing circuitry, may make measurements of the deactivated secondary cell more frequently, thereby permitting determinations regarding whether a measurement report should be issued from which the base station may determine if the primary cell designation for the mobile terminal should be changed and/or the mobile terminal should be handed over to another base station based upon more recent and likely more accurate information even as the location of the mobile terminal changes relatively rapidly. Conversely, in instances in which the speed of the mobile terminal reduces, the apparatus, such as the processing circuitry, may increase the measurement cycle so as to make measurements of the deactivated secondary cell less frequently, thereby conserving power and avoiding unnecessary deactivated secondary cell measurements that may otherwise prove vary only a little, if any, as a result of the mobile terminal being stationary or, at least, moving slowly.

The relationship between the speed of the mobile terminal 10 and the measurement cycles may be defined in various manners, but the apparatus 20, such as the processing circuitry 22, of one embodiment is configured to determine the measurement cycle in accordance with a predefined formula that is at least partially dependent upon the speed of the mobile terminal. For example, the apparatus, such as the processing circuitry, of one embodiment may have a predefined measurement cycle for use in conjunction with the deactivated secondary cells in instances in which the mobile terminal is stationary. As the mobile terminal begins to move, the apparatus, such as the processing circuitry, may reduce the measurement cycle for the deactivated secondary cells from the predefined measurement cycle based upon the speed of the mobile terminal, thereby defining the measurement cycle in accordance with an inverse relationship relative to the speed of a mobile terminal.

The predefined measurement cycle may be defined in advance and stored by the apparatus 20, such as in memory 26. Alternatively, the predefined measurement cycle may optionally be provided to the mobile terminal 10 by the network 14. As shown in block 38 of FIG. 3, for example, the apparatus 20 of one embodiment may include means, such as the processing circuitry 22, the processor 24, the device interface 26 or the like, for receiving a predefined measurement cycle, such as from the network 14. In this embodiment, and as described above, the apparatus, such as processing circuitry, the processor or the like, may then determine the measurement cycle by modifying the predefined measurement cycle based upon the speed of the mobile terminal. Indeed, the measurement cycle that is determined by the apparatus, such as the processing circuitry, may be less than the predefined measurement cycle in an instance in which the mobile terminal is moving as the measurement cycle may have an inverse relationship relative to the speed of the mobile terminal. As such, the predefined measurement cycle, such as that received from the network or stored by the memory, may constitute a maximum measurement cycle with the measurement cycle as determined by the apparatus, such as the processing circuitry, and utilized with respect to the deactivated secondary cell being no more than the predefined measurement cycle, such as in an instance in which the mobile terminal is stationary, and being less than the predefined measurement cycle in some instances, such as an instances in which the mobile terminal is in motion.

As noted above, the apparatus 20, such as the processing circuitry 22, may determine the measurement cycle in accordance with a predefined formula. In one embodiment, however, the apparatus, such as the processing circuitry, defines a plurality of predetermined measurement cycle levels and may associate each of the predetermined measurement cycle levels with a different range of speeds with which the mobile terminal 10 may be moving. For example, the apparatus, such as the processing circuitry, may define a first predetermined measurement cycle level equal to the predefined measurement cycle received from the network for use in an instance in which the mobile terminal is stationary. Additionally, the apparatus, such as the processing circuitry, may define a second predetermined measurement cycle level that is to be utilized in an instance in which the mobile terminal is moving at a speed greater than a predefined maximum speed. Still further, the apparatus, such as the processing circuitry, may define one or more predetermined measurement cycle levels intermediate the first and second measurement cycle levels for use in instances in which the mobile terminal is moving at different rates of speed less than the predefined maximum speed. By way of example, one set of predetermined measurement cycle levels and the corresponding speeds of the mobile terminal at which the predetermined measurement cycle levels would be utilized is shown below by way of an example, but not of limitation.

| Speed | Measurement Cycle |
|---|---|
| 0 km/h | 1280 ms |
| Between 0 km/h and 40 km/h | 1000 ms |
| Between 40 km/h and 80 km/h | 720 ms |
| Between 80 km/h and 120 km/h | 440 ms |
| Greater than 120 km/h | 160 ms |

The apparatus 20, such as the processing circuitry 22, the processor 24 or the like, of one embodiment may alternatively determine the measurement cycle based upon the speed of the mobile terminal 10 in an implicit manner. For example, the apparatus, such as the processing circuitry, may determine the speed of the mobile terminal based upon speed information that is generated for other purposes, such as the GPS speed, or that may be determined implicitly from measurements of the primary cell.

Regardless of the manner in which the measurement cycle is determined, as shown in block 44 of FIG. 3, the apparatus 20, such as the processing circuitry 22, the processor 24, the device interface 28 or the like, may cause signals from at least one deactivated secondary cell to be measured in accordance with the measurement cycle. The apparatus may measure various parameters associated with the signals from the deactivated secondary cell(s), as well as from the primary cell and any active secondary cell(s). For example, the apparatus may measure the primary cell CQI, the reference signal received power (RSRP), the reference signal received quality (RSRQ) or other indication of a downlink signal level. Based upon the measurements of the signals from the primary cell, the active secondary cell(s) and the deactivated secondary cell(s), the apparatus, such as the processing circuitry, may determine if a measurement report is to be issued that may trigger the network 14 to to change the primary cell designation, such as from the current primary cell to a current secondary cell, or to hand over the mobile station to another base station 16, such as in instances in which the measurements of the signals from a secondary cell over a measurement period are better, such as in terms of quality, strength and/or the like, than the signals from the primary cell. By modifying the measurement cycle with which the mobile terminal 10 obtains deactivated secondary cell measurements based upon the speed with which the mobile terminal is moving, the mobile terminal may obtain, for example, more frequent deactivated secondary cell measurements in an instance in which the mobile terminal is moving quickly so as to allow a better and more accurate comparison between the deactivated secondary cell measurements and the primary cell measurements for purposes, for example, of issuing a measurement report that may change the primary cell designation or cause handover of the mobile terminal to another base station 16. However, the method, apparatus and computer program product of the embodiments of the present invention permit the measurement cycle for the deactivated secondary cell measurement to remain appreciably longer than the primary cell measurement cycle in instances in which the mobile terminal is stationary or is otherwise not moving very quickly, thereby permitting power to be conserved in an instance in which the motion of the mobile terminal does not significantly adversely affect the validity of the secondary cell measurements.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. For example, the mobile terminal 10 is described herein to provide measurement reports from which the base station 16 may determine whether there should be a primary cell redesignation or a handover, the mobile terminal of another embodiment may make such determinations itself regarding primary cell designation and/or handover. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
determining a speed with which a mobile terminal is moving;
determining, via processing circuitry, a measurement cycle based upon the speed of the mobile terminal; and
causing signals from at least one deactivated secondary cell to be measured in accordance with the measurement cycle.

2. A method according to claim 1 further comprising receiving a predefined measurement cycle, wherein determining the measurement cycle comprises modifying the predefined measurement cycle based upon the speed of the mobile terminal.

3. A method according to claim 2 wherein the predefined measurement cycle comprises a maximum measurement cycle.

4. A method according to claim 1 wherein determining the measurement cycle comprises determining the measurement cycle in accordance with an inverse relationship relative to the speed of the mobile terminal.

5. A method according to claim 1 wherein determining the measurement cycle comprises selecting one of a plurality of predetermined measurement cycle levels based upon the speed of the mobile terminal.

6. A method according to claim 1 wherein determining the measurement cycle comprises determining the measurement cycle in accordance with a predefined formula that is at least partially dependent upon the speed of the mobile terminal.

7. An apparatus comprising processing circuitry configured at least to:
determine a speed with which a mobile terminal is moving;
determine a measurement cycle based upon the speed of the mobile terminal; and
cause signals from at least one deactivated secondary cell to be measured in accordance with the measurement cycle.

8. An apparatus according to claim 7 wherein the processing circuitry is further configured to receive a predefined measurement cycle, wherein the processing circuitry is configured to determine the measurement cycle by modifying the predefined measurement cycle based upon the speed of the mobile terminal.

9. An apparatus according to claim 8 wherein the predefined measurement cycle comprises a maximum measurement cycle.

10. An apparatus according to claim 7 wherein the processing circuitry is configured to determine the measurement cycle by determining the measurement cycle in accordance with an inverse relationship relative to the speed of the mobile terminal.

11. An apparatus according to claim 7 wherein the processing circuitry is configured to determine the measurement cycle by selecting one of a plurality of predetermined measurement cycle levels based upon the speed of the mobile terminal.

12. An apparatus according to claim 7 wherein the processing circuitry is configured to determine the measurement cycle by determining the measurement cycle in accordance with a predefined formula that is at least partially dependent upon the speed of the mobile terminal.

13. A computer program product comprising at least one non-transitory computer-readable storage medium having computer-readable program instructions stored therein, the computer-readable program instructions comprising program instructions configured to:
determine a speed with which a mobile terminal is moving;
determine a measurement cycle based upon the speed of the mobile terminal; and
cause signals from at least one deactivated secondary cell to be measured in accordance with the measurement cycle.

14. A computer program product according to claim 13 further comprising program instructions configured to receive a predefined measurement cycle, wherein the program instructions for determining the measurement cycle comprise program instructions configured to modify the predefined measurement cycle based upon the speed of the mobile terminal.

15. A computer program product according to claim 14 wherein the predefined measurement cycle comprises a maximum measurement cycle.

16. A computer program product according to claim 13 wherein the program instructions for determining the measurement cycle comprise program instructions configured to determine the measurement cycle in accordance with an inverse relationship relative to the speed of the mobile terminal.

17. A computer program product according to claim 13 wherein the program instructions for determining the measurement cycle comprise program instructions configured to select one of a plurality of predetermined measurement cycle levels based upon the speed of the mobile terminal.

18. A computer program product according to claim 13 wherein the program instructions for determining the measurement cycle comprise program instructions configured to determine the measurement cycle in accordance with a predefined formula that is at least partially dependent upon the speed of the mobile terminal.
